(19) United States
(12) Patent Application Publication
(10) Pub. No.: US 2024/0014450 A1
(43) Pub. Date: Jan. 11, 2024

(54) SAFETY INTERCONNECT FOR A MODULAR HIGH-VOLTAGE BATTERY SYSTEM

(71) Applicant: Atieva, Inc., Newark, CA (US)

(72) Inventors: David Pui-Yin Tse, San Jose, CA (US); James Hawkins, Fremont, CA (US); Pablo Ramaswamy, Newark, CA (US)

(21) Appl. No.: 18/194,218

(22) Filed: Mar. 31, 2023

Related U.S. Application Data
(60) Provisional application No. 63/367,954, filed on Jul. 8, 2022.

(51) Int. Cl. H01M 10/42; H01M 50/505; H01M 50/583; H01M 10/48

(52) U.S. Cl. CPC H01M 10/4207; H01M 50/505; H01M 50/583; H01M 10/482; H01M 2220/20

(57) ABSTRACT

A safety interconnect for a modular high-voltage battery system comprises: a housing of an electrically insulating material, the housing having a cavity with an opening; and a busbar contained within the cavity, the busbar comprising a first terminal for connecting to a first external terminal of a first module of a modular high-voltage battery system, and a second terminal for connecting to a second external terminal of a second module of the modular high-voltage battery system adjacent the first module.

### CROSS-REFERENCE TO RELATED APPLICATION

This application claims benefit, under 35 U.S.C. § 119, of U.S. Provisional Patent Application No. 63/367,954, filed on Jul. 8, 2022, entitled “SAFETY INTERCONNECT FOR A MODULAR HIGH-VOLTAGE BATTERY SYSTEM,” the disclosure of which is incorporated by reference herein in its entirety.

### TECHNICAL FIELD

This document relates to a safety interconnect for a modular high-voltage battery system.

### BACKGROUND

In recent years, the world's transportation has begun a transition away from powertrains primarily driven by fossil fuels and toward more sustainable energy sources. The majority of such increasingly prevalent powertrains include electric motors powered by on-board energy storages. In order to make these new modes of transportation available to larger segments of population, vehicle makers are striving to reduce the cost of manufacturing, assembling, operating and servicing electric vehicles.

Some existing battery packs of electric vehicles have modules of cells where the modules are electrically coupled to each other by bolted joints. This approach is associated with costs and time expense during manufacture and service. Moreover, disassembling the pack (e.g., removing a module) requires the service technician to have extensive high-voltage safety training and to use special high-voltage equipment.

### SUMMARY

In a first aspect, a safety interconnect for a modular high-voltage battery system comprises: a housing of an electrically insulating material, the housing having a cavity with an opening; and a busbar contained within the cavity, the busbar comprising a first terminal for connecting to a first external terminal of the first module of a modular high-voltage battery system, and a second terminal for connecting to a second external terminal of a second module of the modular high-voltage battery system adjacent the first module.

Implementations can include any or all of the following features. The housing comprises (i) sidewalls that are pairwise substantially perpendicular to each other, and (ii) a bottom wall that faces the opening and is substantially perpendicular to each of the sidewalls. Ends of the first and second terminals are positioned at a distance from the opening inside the cavity. The first and second terminals are blades. The busbar is elongate and wherein the first and second terminals extend substantially parallel with a longitudinal axis of the busbar. The safety interconnect is configured for sliding of the first and second terminals into contact with the first and second external terminals, respectively. The safety interconnect further comprises an electrically insulated grip on the housing. The safety interconnect further comprises an active current disconnect in the cavity for severing the busbar between the first and second terminals. The active current disconnect comprises a pyrotechnic fuse. The active current disconnect is configured for permanently severing the busbar. The safety interconnect further comprises a receptacle for a connector that provides a signal to actuate the active current disconnect, the receptacle positioned on an outside of the housing. The safety interconnect further comprises a current sensor inside the housing, the current sensor configured for generating a signal to actuate the active current disconnect. The housing comprises an injection molded material.

In a second aspect, a method of manufacturing a modular high-voltage battery system comprises: installing first and second modules of the modular high-voltage battery system adjacent each other; and mounting a safety interconnect to the first and second modules, the safety interconnect including (i) a housing of an electrically insulating material, the housing having a cavity with an opening, and (ii) a busbar contained within the cavity, the busbar having a first terminal for connecting to a first external terminal of the first module, and a second terminal for connecting to a second external terminal of the second module.

Implementations can include any or all of the following features. Mounting the safety interconnect comprises sliding the first and second terminals into contact with the first and second external terminals, respectively. The safety interconnect further includes an active current disconnect in the cavity for severing the busbar between the first and second terminals. The safety interconnect further comprises a receptacle on an outside of the housing, and wherein mounting the safety interconnect further comprises coupling a connector to the receptacle, the connector providing a signal to actuate the active current disconnect.

In a third aspect, a method of operating a modular high-voltage battery system comprises: detecting a safety-related event regarding the modular high-voltage battery system including first and second modules adjacent each other, the modular high-voltage battery system including a safety interconnect mounted to the first and second modules, the safety interconnect including (i) a housing of an electrically insulating material, the housing having a cavity with an opening, (ii) a busbar contained within the cavity, the busbar having a first terminal for connecting to a first external terminal of the first module, and a second terminal for connecting to a second external terminal of the second module, and (iii) an active current disconnect; and actuating the active current disconnect in response to the safety-related event.

Implementations can include any or all of the following features. The safety-related event is detected by the safety interconnect. The safety-related event is detected using a current sensor inside the housing.

In a fourth aspect, a method of servicing a modular high-voltage battery system comprises: accessing, by a service technician, an installation of the modular high-voltage battery system; and removing, by the service technician, a safety interconnect mounted to first and second modules of the modular high-voltage battery system, the second module adjacent the first module, the safety interconnect including (i) a housing of an electrically insulating material, the housing having a cavity with an opening, and (ii) a busbar contained within the cavity, the busbar having a first terminal for connecting to a first external terminal of the first module, and a second terminal for connecting to a second external terminal of the second module.

Implementations can include any or all of the following features. Removing the safety interconnect comprises sliding the first and second terminals out of contact with the first and second external terminals, respectively. The method further comprises subsequently mounting the safety interconnect to the first and second modules. The safety interconnect further includes an active current disconnect in the cavity for severing the busbar between the first and second terminals. The safety interconnect is removed after the active current disconnect has been actuated.

### BRIEF DESCRIPTION OF DRAWINGS

FIG. 1 shows an example of perspective view of a safety interconnect for a modular high-voltage battery system.

FIG. 2 shows an example of an electric vehicle having a modular high-voltage battery system.

FIG. 3 shows an example of modules of electrochemical cells for a modular high-voltage battery system.

FIG. 4 shows an example of external terminals that can be used with the modules of FIG. 3.

FIG. 5 shows an example of the safety interconnect of FIG. 1 mounted to the modules of FIG. 3.

FIGS. 6A-6B show examples of front and rear views of the busbar of the safety interconnect of FIG. 1.

FIGS. 7A-7B show examples of top and bottom views of the busbar of the safety interconnect of FIG. 1.

FIGS. 8A-8B show examples of front and rear views of the safety interconnect of FIG. 1.

FIG. 9 shows an example cross section view of the safety interconnect of FIG. 1.

Like reference symbols in the various drawings indicate like elements.

### DETAILED DESCRIPTION

This document describes examples of systems and techniques for providing safety interconnects between modules of electrochemical cells in a high-voltage battery system. Such a high-voltage battery system can be used in a vehicle and/or in a stationary power supply. Safety interconnects can allow a high voltage of the system to be broken down into smaller chunks. This can enable safe servicing of individual modules to be performed in a service center without specialist high-voltage equipment or training. An active current disconnect can be provided in the safety interconnect. In some implementations, a safety interconnect comprises a removable jumper between modules that includes an active fuse (e.g., a pyrotechnic fuse, or pyrofuse for short). For example, this can allow the battery high voltage circuit to be actively and instantly broken down into safe values for service, and/or in cases of damage or water ingress to prevent hazardous conditions. A safety interconnect can be finger safe for removal, meaning that previous connection approaches such as bolted joints are eliminated. This can provide low contact resistance, enable ease of serviceability, and eliminate the need to torque bolts and the tracking and documentation associated with these operations. As such, a safety interconnect can enhance the high-voltage safety architecture.

Examples herein refer to a battery system, which is an assembly of electrochemical cells. A battery system can be configured to power an electric motor for propulsion, or to provide a stationary power supply, to name just two examples. Examples herein refer to a battery module, which is an individual component configured for holding and managing multiple electrochemical cells during charging, storage, and use. A battery system can include any number of modules. The battery module can be intended as the sole power source for one or more loads (e.g., electric motors), or more than one battery module of the same or different type can be used. A battery system can include two or more battery modules of the same or different type. A battery module can include control circuitry for managing the charging, storage, and/or use of electrical energy in the electrochemical cells, or the battery module can be controlled by an external component. For example, a battery management system can be implemented on one or more circuit boards (e.g., a printed circuit board).

Examples herein refer to a battery system having high voltage, sometimes referred to as a high-voltage battery system. Having high voltage involves an operating voltage or difference in potential that is generally considered lethal if contacted by humans. High voltage as used herein means at least about 250 volt (V). Voltages specified herein are direct current (DC) voltages. In some implementations, a high voltage battery system can have a voltage of more than about 300 V. In some implementations, a high voltage battery system can have a voltage of more than about 400 V. In some implementations, a high voltage battery system can have a voltage of more than about 500 V. In some implementations, a high voltage battery system can have a voltage of more than about 600V. In some implementations, a high voltage battery system can have a voltage of more than about 700 V. In some implementations, a high voltage battery system can have a voltage of more than about 800V. In some implementations, a high voltage battery system can have a voltage of more than about 900 V. By contrast, a battery terminal or other conductive element that is considered acceptable also for service personnel without special high voltage tools or high voltage training can be referred to as having a non-lethal voltage. For example, making a high voltage battery system (e.g., one having a voltage of more than about 900 V) serviceable without special high voltage tools or high voltage training can involve ensuring that high voltage terminals are not exposed to service personnel, and that only terminals of a non-lethal voltage are exposed, to the service personnel.

Examples herein refer to electrochemical cells. An electrochemical cell can include an electrolyte and two electrodes to store energy and deliver it when used. In some implementations, the electrochemical cell can be a rechargeable cell. For example, the electrochemical cell can be a lithium-ion cell. In some implementations, the electrochemical cell can act as a galvanic cell when being discharged, and as an electrolytic cell when being charged. The electrochemical cell can have at least one terminal for each of the electrodes. The terminals, or at least a portion thereof, can be positioned at one end of the electrolytic cell. For example, when the electrochemical cell has a cylindrical shape, one of the terminals can be provided in the center of the end of the cell, and the can that forms the cylinder can constitute the other terminal and therefore be present at the end as well. Other shapes of electrochemical cells can be used, including, but not limited to, prismatic shapes.

Examples herein refer to a busbar, and a safety interconnect or a battery module can have at least one busbar. The busbar is electrically conductive and is used for conducting electricity, for example between two modules of a high-voltage battery system. The busbar is made of an electrically conductive material (e.g., metal) and has suitable dimensions for the intended levels of current and voltage. In some implementations, the busbar comprises aluminum (e.g., an aluminum alloy). A busbar can be planar (e.g., flat) or can have one or more bends, to name just a few examples.

Examples described herein refer to a top, bottom, front, or rear. These and similar expressions identify things or aspects in a relative way based on an express or arbitrary notion of perspective. That is, these terms are illustrative only, used for purposes of explanation, and do not necessarily indicate the only possible position, direction, and so on.

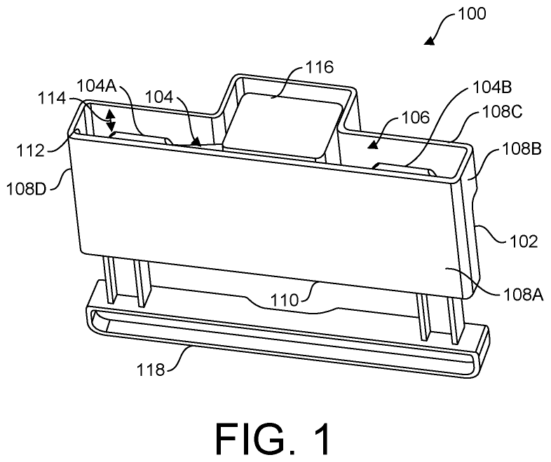

FIG. 1 shows an example of perspective view of a safety interconnect 100 for a modular high-voltage battery system. The safety interconnect 100 can be used with one or more other examples described elsewhere herein. The safety interconnect 100 includes a housing 102 of an electrically insulating material. In some implementations, the housing 102 can be molded (e.g., injection molded) from a polymer material, to name just one example. The safety interconnect 100 includes a busbar 104, of which terminals 104A-104B are visible. The busbar 104 is contained within a cavity 106 of the housing 102. For example, the housing 102 includes sidewalls 108A-108D that are pairwise substantially perpendicular to each other. As another example, the housing 102 includes a bottom wall 110 that faces an opening 112 of the cavity 106 and that is substantially perpendicular to each of the sidewalls 108A-108D.

The terminals 104A-104B can have any shape. Here, the terminals 104A-104B are blades. For example, the blades can be oriented so as to be substantially parallel with a longitudinal axis of the busbar 104. Other shapes can be used for the terminals 104A-104B, including, but not limited to, a barrel shape, or a cylindrical shape. The terminals 104A-104B, like the rest of the busbar 104, are contained within the cavity 106. For example, a distance 114 can extend between the respective ends of the terminals 104A-104B and the opening 112.

The safety interconnect 100 can include an active current disconnect 116 coupled to the busbar 104. The active current disconnect 116 can be positioned in the cavity 106. When actuated, the active current disconnect 116 can sever the busbar 104 between the terminals 104A-104B. In some implementations, the active current disconnect 116 includes a pyrotechnic fuse. As another example, the active current disconnect 116 can include a contactor that can be controlled for interrupting the electrical connection between the terminals 104A-104B.

The safety interconnect 100 can include a grip 118. The grip 118 can be formed by, or otherwise coupled to, the housing 102. For example, the grip 118 can include a handle attached to (a remainder of) the housing 102 by one or more posts (e.g., as shown).

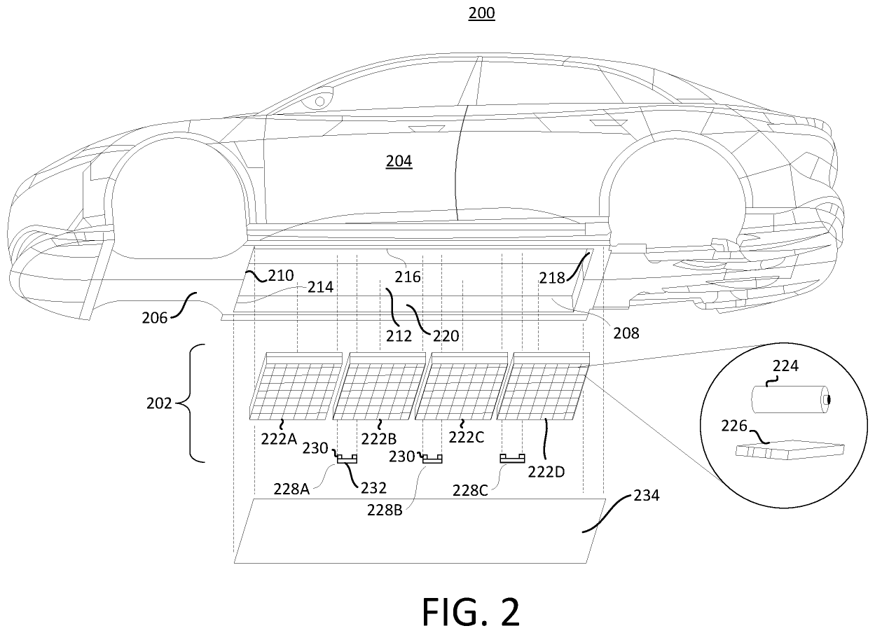

FIG. 2 shows an example of an electric vehicle (EV) 200 having a high-voltage (HV) battery system 202. The EV 200 is shown in an exploded view for illustrative purposes. The EV 200 and/or the HV battery system 202 can be used with one or more other examples described elsewhere herein. The EV 200 has one or more electric traction motors (not shown) to be powered by the HV battery system 202. Some other components of the EV 200 (including, but not limited to, wheels) are omitted in this illustration for clarity.

The EV 200 includes a vehicle body 204. The vehicle body 204 can include various structural components that together make up the framework and the multiple sections of the EV 200. In some implementations, the EV 200 includes a frame that is assembled from a number of individual sections. In some implementations, the EV 200 includes a chassis 206. For example, the chassis 206 can form the supporting structure for the vehicle body 204 and can be made using various frame components, rails, rockers, torque boxes, and/or cross-members.

The EV 200 has a cavity 208 in the vehicle body 204. The cavity 208 is here in part defined by an opening 210. The cavity 208 can be formed in any of various sections or portions of the vehicle body 204. In some implementations, the cavity 208 is formed in the chassis 206 of the vehicle body 204. For example, the cavity 208 can be configured so that the opening 210 faces toward ground on which the EV 200 is positioned.

The cavity 208 can have any shape, including, but not limited to, a rectilinear shape. In some implementations, the cavity is formed by a number of walls of the vehicle body 204. For example, the cavity 208 can at least in part be formed by a rear wall 212. As another example, the cavity 208 can at least in part be formed by a side wall 214 (obscured in the present illustration). As another example, the cavity 208 can at least in part be formed by a side wall 216 (obscured in the present illustration). As another example, the cavity 208 can at least in part be formed by a side wall 218. As another example, the cavity 208 can at least in part be formed by a side wall 220. The rear wall 212 can face (e.g., be substantially parallel with) the opening 210. One or more of the side walls 214-220 can be substantially perpendicular to the rear wall 212. The cavity 106 can have other shapes.

The HV battery system 202 can include multiple modules of electrochemical cells, sometimes referred to as battery cell collectors because each of them serves to contain multiple electrochemical cells. Here, the HV battery system 202 includes modules 222A-222D of electrochemical cells. The modules 222A-222D are components that comprise the HV battery system 202. The modules 222A-222D can be positioned in any arrangement within the cavity 208. Each of the modules 222A-222D can be an individual unit that can be manufactured separately and installed in the cavity 208. For example, each of the modules 222A-222D can be mounted to (e.g., abutting) the rear wall 212. The HV battery system 202 may or may not have a standalone pack enclosure (not shown).

Each of the modules 222A-222D includes multiple electrochemical cells. The electrochemical cells can have one or more of multiple form factors. In some implementations, the HV battery system 202 can use an electrochemical cell 224 having a cylinder shape. In some implementations, the HV battery system 202 can use an electrochemical cell 226 having a prismatic shape. Other form factors can be used.

The HV battery system 202 can include electrical interconnects to couple the modules 222A-222D to each other and/or to other electrical fittings within the cavity 208. Here, the HV battery system 202 includes electrical interconnects 228A-228C. The electrical interconnects 228A-228C are components that comprise the HV battery system 202. The electrical interconnects 228A-228C can serve one or more of multiple purposes. For example, the electrical interconnects 228A-228C can connect two or more of the modules 222A-222D to each other and thereby increase the overall voltage from a module-level voltage (e.g., a non-lethal voltage) to a battery system-level voltage (e.g., a lethal voltage). As another example, one or more of the electrical interconnects 228A-228C can be selectively removed (e.g., for a service session) so as to reduce the overall voltage from the battery system-level voltage to the module-level voltage. For example, the safety interconnect 100 (FIG. 1) can be used as one or more of the electrical interconnects 228A-228C.

Each of the electrical interconnects 228A-228C can include a busbar that is partially covered by insulation. For example, the electrical interconnect 228A includes a busbar that provides terminals 230, and also includes insulation 232 that covers the busbar. In some implementations, the electrical interconnect 228A can electrically connect the modules 222A-222B to each other. In some implementations, the electrical interconnect 228B can electrically connect the modules 222B-222C to each other. In some implementations, the electrical interconnect 228C can electrically connect the modules 222C-222D to each other.

The EV 200 includes a closure 234 that is configured for closing the opening 210 of the cavity 208. The closure 234 can include a member of metal and/or composite material. In some implementations, the closure 234 is in form of a sheet of material serving as a shield for the cavity 106. Other shapes can be used for the closure 234.

The electrical interconnects 228A-228C can provide advantages relating to serviceability of the EV 200. For example, after removal of the closure 234, with the electrical interconnects 228A-228C remaining installed in their respective places, no high voltage terminal of the HV battery system 202 is exposed to the technician. Rather, the insulation of the electrical interconnects 228A-228C serves to cover, and thereby prevent inadvertent contact with, high voltage terminals or other conductors. Service personnel can then remove one or more of the electrical interconnects 228A-228C. Any of multiple ways of removal can be used. In some implementations, the electrical interconnects 228A-228C can be removed by way of grasping the insulated portion of, and pulling on, the respective electrical interconnect 228A-228C. In some implementations, the electrical interconnects 228A-228C can be removed by rotating or otherwise moving a component. For example, a screw of a plastic material can be surrounded by insulation such that the removal can be performed using a conventional screwdriver and no specialty tools.

Removal of the electrical interconnect severs the electrical connection between the corresponding ones of the modules 222A-222D and thereby reduces the voltage from a system voltage level (e.g., a lethal voltage) to a module-level voltage (e.g., a non-lethal voltage). The present subject matter can make the HV battery system 202 “finger safe” in that it allows the HV battery system 202 to be serviced without special high voltage tools or high voltage training. That is, the HV battery system 202 is disconnected to be a fraction of the complete battery system voltage before any of the modules 222A-222D can be accessed for service. For example, each of the modules 222A-222D has a voltage lower than the voltage of the HV battery system 202.

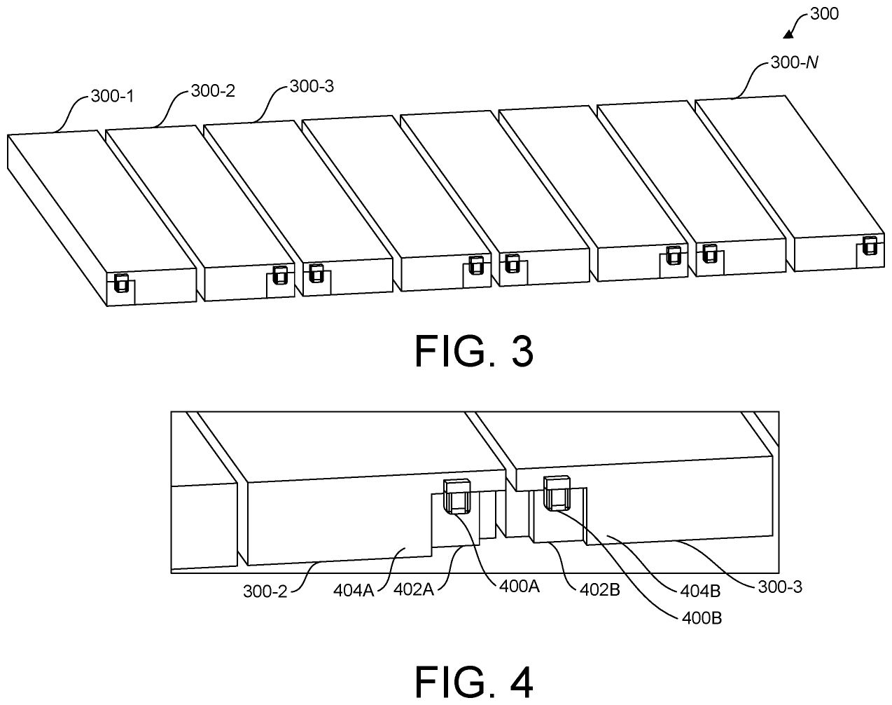

FIG. 3 shows an example of modules 300 of electrochemical cells for a modular high-voltage battery system. The modules 300 can be used with one or more other examples described elsewhere herein. Any number of modules can be included. Here, modules 300-1, 300-2, 300-3, . . . , 300-N are indicated, where N is any integer. The modules 300 can be placed in any configuration relative to each other. For example, here the modules 300 are arranged in a row where each of the modules 300 sits adjacent one or two others of the modules 300. Each of the modules 300 includes multiple electrochemical cells (not shown). For example, each of the modules 300 can include the same number of electrochemical cells. Other approaches can be used.

FIG. 4 shows an example of external terminals 400A-400B that can be used with the modules 300 of FIG. 3. For example, the external terminals 400A-400B are here part of the modules 300-2 and 300-3, respectively. The external terminals 400A-400B can be used with one or more other examples described elsewhere herein.

The module 300-2 includes a mounting area 402A that can be used for mounting a safety interconnect to the module 300-2. For example, the mounting area 402A is recessed from a front face 404A of the module 300-2. The external terminal 400A is connected to one or more busbars (not shown) inside the module 300-2 and thereby to the electrochemical cells of the module 300-2. The external terminal 400A is here accommodated by the mounting area 402A.

Similarly, the module 300-3 includes a mounting area 402B that can be used for mounting a safety interconnect to the module 300-3. For example, the mounting area 402B is recessed from a front face 404B of the module 300-3. The external terminal 400B is connected to one or more busbars (not shown) inside the module 300-3 and thereby to the electrochemical cells of the module 300-3. The external terminal 400B is here accommodated by the mounting area 402B. The mounting areas 402A-402B can be positioned relative to each other. For example, the mounting area 402A is here positioned at a corner of the module 300-2 (e.g., a front right corner) that is closest to a corner of the module 300-3 (e.g., a front left corner) where the mounting area 402B is here positioned.

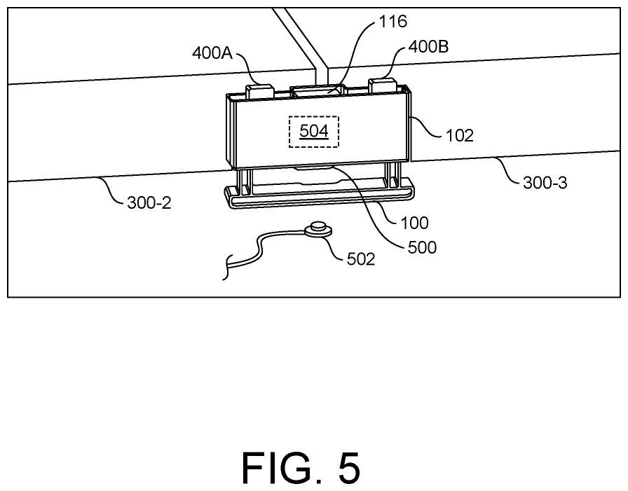

FIG. 5 shows an example of the safety interconnect 100 of FIG. 1 mounted to the modules 300-2 and 300-3 of FIG. 3. That is, the safety interconnect 100 has been placed for sliding of the terminals 104A-104B into contact with the external terminals 400A-400B, respectively. The sliding contact between the terminals 104A-104B into contact with the external terminals 400A-400B, and/or an interfacing between the housing 102 and either of the modules 300-2 and 300-3, can secure the safety interconnect 100 in its present position.

The safety interconnect 100 can include a receptacle 500 on an outside of the housing 102. The receptacle 500 can be used for a connector 502 that provides a signal to actuate the active current disconnect 116. For example, the receptacle 500 and the connector 502 can be a so-called squib connector.

One or more detected circumstances or characteristics can trigger actuation of the active current disconnect 116. This can involve detecting a safety-related event regarding the high-voltage battery system. In some implementations, an electrical overcurrent, or ingress of a foreign substance (e.g., liquid) into the high-voltage battery system, can cause the active current disconnect 116 to be actuated to sever the busbar in response to the safety-related event. For example, one or more sensors (including, but not limited to, a current sensor and/or a liquid sensor) can be positioned inside the high-voltage battery system and cause a signal to be generated (e.g., by a battery management unit) to the connector 502, which signal triggers actuation of the active current disconnect 116. For example, the conductor of the connector 502 can also provide a power supply for energizing the active current disconnect 116.

In some implementations, the safety interconnect 100 can include at least one sensor 504 to detect a circumstance or characteristic to trigger actuation of the active current disconnect 116. For example, the sensor 504 can include a current sensor. As such, the safety interconnect 100 can trigger the active current disconnect 116.

In a method of manufacturing a modular high-voltage battery system, the modules 300-2 and 300-3 can be installed adjacent each other (e.g., in the EV 200 of FIG. 2). The safety interconnect 100 can be mounted to the modules 300-2 and 300-3. For example, this can involve relative sliding between on the one hand the safety interconnect 100 and on the other the modules 300-2 and 300-3.

In a method of servicing a modular high-voltage battery system, a service technician can access an installation of a modular high-voltage battery system (e.g., in the EV 200 of FIG. 2). The service technician can remove the safety interconnect 100 (e.g., by pulling or pushing). This reduces the voltage of the battery system to a non-lethal level. When service is completed, the service technician can subsequently mount the safety interconnect 100 to the modules. The removal of the safety interconnect 100 can be done whenever the modular high-voltage battery system is subject to service, including, but not limited to, after the active current disconnect 116 has been actuated.

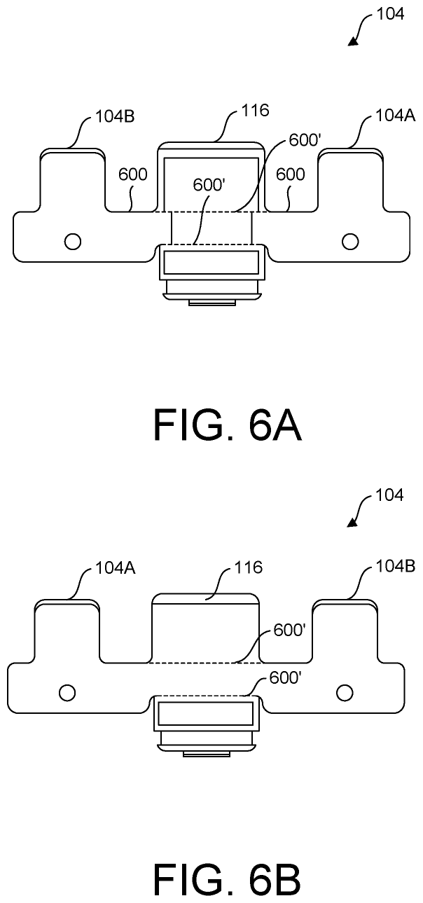

FIGS. 6A-6B show examples of front and rear views of the busbar 104 of the safety interconnect 100 of FIG. 1. The busbar 104 can be used with one or more other examples described elsewhere herein. The busbar 104 can be elongate and include a busbar body 600 that extends between the terminals 104A-104B. The active current disconnect 116 can include at least one igniter and at least one severing tool, and can be positioned against the busbar body 600. Particularly, the active current disconnect 116 can be configured for severing a portion 600′ of the busbar body 600. Such severing can be permanent when the safety interconnect 100 does not provide for the busbar body 600 to be restored into a conductive element. As another example, such severing can be considered temporary (or reversible) when the safety interconnect 100 does provide for the busbar body 600 to be restored into a conductive element (e.g., by returning a contactor to a closed position).

In other implementations where the safety interconnect 100 does not include the active current disconnect 116, the portion 600′ can form a permanent electrical connection between the terminals 104A-104B.

In a method of operating a modular high-voltage battery system, a safety-related event can be detected (e.g., by the safety interconnect 100 or by a sensor external to the safety interconnect 100). The active current disconnect 116 can be actuated in response to the safety-related event.

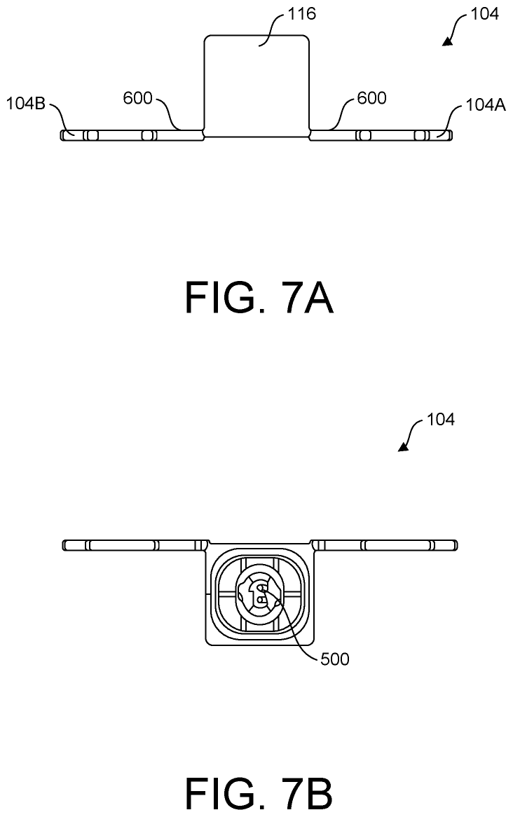

FIGS. 7A-7B show examples of top and bottom views of the busbar 104 of the safety interconnect 100 of FIG. 1. The busbar 104 can be elongate and the terminals 104A-104B can extend substantially parallel with a longitudinal axis of the busbar 104. The active current disconnect 116 can be positioned on one side of the busbar body 600.

The receptacle 500 can include any electrical contactors or terminals configured to interface with the connector 502 (FIG. 5), including, but not limited to, by at least two pins configured for receiving current to trigger actuation of the active current disconnect 116.

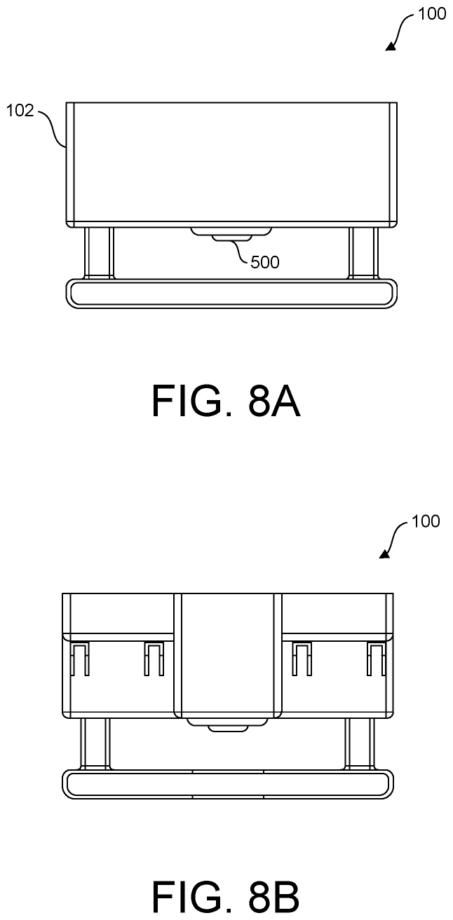

FIGS. 8A-8B show examples of front and rear views of the safety interconnect 100 of FIG. 1. The housing 102 contains the terminals 104A-104B (FIG. 1). In some implementations, the safety interconnect 100 can make a modular high-voltage battery system finger safe. For example, the distance 114 (FIG. 1) can ensure that the electrical connection formed between the external terminals 400A-400B (FIG. 4) by the safety interconnect 100 is interrupted (and therefore no longer a high voltage), before any portion of the terminals 104A-104B can be reached by a technician.

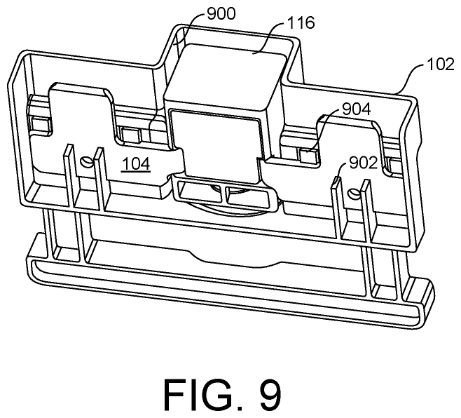

FIG. 9 shows an example cross section view of the safety interconnect 100 of FIG. 1. The housing 102 of the safety interconnect 100 can provide a space 900 that at least partially accommodates the active current disconnect 116. The housing 102 can provide at least one structure 902 or 904 for positioning the busbar 104. For example, the structure 902 can be a tab that engages (e.g., by a friction fit) with the busbar 104 to hold the busbar 104 in place within the cavity 106. As another example, the structure 904 can be a catch that engages (e.g., by an interlocking fit) with the busbar 104 to hold the busbar 104 in place within the cavity 106. Other approaches can be used.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A safety interconnect for a modular high-voltage battery system, the safety interconnect comprising:
a housing of an electrically insulating material, the housing having a cavity with an opening; and
a busbar contained within the cavity, the busbar comprising a first terminal for connecting to a first external terminal of a first module of the modular high-voltage battery system, and a second terminal for connecting to a second external terminal of a second module of the modular high-voltage battery system adjacent the first module.

2. The safety interconnect of claim 1, wherein the housing comprises (i) sidewalls that are pairwise substantially perpendicular to each other, and (ii) a bottom wall that faces the opening and is substantially perpendicular to each of the sidewalls.

3. The safety interconnect of claim 1, wherein ends of the first and second terminals are positioned at a distance from the opening inside the cavity.

4. The safety interconnect of claim 1, wherein the first and second terminals are blades.

5. The safety interconnect of claim 4, wherein the busbar is elongate and wherein the first and second terminals extend substantially parallel with a longitudinal axis of the busbar.

6. The safety interconnect of claim 1, wherein the safety interconnect is configured for sliding of the first and second terminals into contact with the first and second external terminals, respectively.

7. The safety interconnect of claim 1, further comprising an electrically insulated grip on the housing.

8. The safety interconnect of claim 1, further comprising an active current disconnect in the cavity for severing the busbar between the first and second terminals.

9. The safety interconnect of claim 8, wherein the active current disconnect comprises a pyrotechnic fuse.

10. The safety interconnect of claim 8, wherein the active current disconnect is configured for permanently severing the busbar.

11. The safety interconnect of claim 8, further comprising a receptacle for a connector that provides a signal to actuate the active current disconnect, the receptacle positioned on an outside of the housing.

12. The safety interconnect of claim 8, further comprising a current sensor inside the housing, the current sensor configured for generating a signal to actuate the active current disconnect.

13. The safety interconnect of claim 1, wherein the housing comprises an injection molded material.

14. A method of manufacturing a modular high-voltage battery system, the method comprising:
installing first and second modules of the modular high-voltage battery system adjacent each other; and
mounting a safety interconnect to the first and second modules, the safety interconnect including (i) a housing of an electrically insulating material, the housing having a cavity with an opening, and (ii) a busbar contained within the cavity, the busbar having a first terminal for connecting to a first external terminal of the first module, and a second terminal for connecting to a second external terminal of the second module.

15. The method of claim 14, wherein mounting the safety interconnect comprises sliding the first and second terminals into contact with the first and second external terminals, respectively.

16. The method of claim 14, wherein the safety interconnect further includes an active current disconnect in the cavity for severing the busbar between the first and second terminals.

17. The method of claim 16, wherein the safety interconnect further comprises a receptacle on an outside of the housing, and wherein mounting the safety interconnect further comprises coupling a connector to the receptacle, the connector providing a signal to actuate the active current disconnect.

18. A method of operating a modular high-voltage battery system, the method comprising:
detecting a safety-related event regarding the modular high-voltage battery system including first and second modules adjacent each other, the modular high-voltage battery system including a safety interconnect mounted to the first and second modules, the safety interconnect including (i) a housing of an electrically insulating material, the housing having a cavity with an opening, (ii) a busbar contained within the cavity, the busbar having a first terminal for connecting to a first external terminal of the first module, and a second terminal for connecting to a second external terminal of the second module, and (iii) an active current disconnect; and
actuating the active current disconnect in response to the safety-related event.

19. The method of claim 18, wherein the safety-related event is detected by the safety interconnect.

20. The method of claim 19, wherein the safety-related event is detected using a current sensor inside the housing.

21. A method of servicing a modular high-voltage battery system, the method comprising:
accessing, by a service technician, an installation of the modular high-voltage battery system; and
removing, by the service technician, a safety interconnect mounted to first and second modules of the modular high-voltage battery system, the second module adjacent the first module, the safety interconnect including (i) a housing of an electrically insulating material, the housing having a cavity with an opening, and (ii) a busbar contained within the cavity, the busbar having a first terminal for connecting to a first external terminal of the first module, and a second terminal for connecting to a second external terminal of the second module.

22. The method of claim 21, wherein removing the safety interconnect comprises sliding the first and second terminals out of contact with the first and second external terminals, respectively.

23. The method of claim 21, further comprising subsequently mounting the safety interconnect to the first and second modules.

24. The method of claim 21, wherein the safety interconnect further includes an active current disconnect in the cavity for severing the busbar between the first and second terminals.

25. The method of claim 24, wherein the safety interconnect is removed after the active current disconnect has been actuated.
